(19) United States
(12) Patent Application Publication
(10) Pub. No.: US 2004/0167647 A1
(43) Pub. Date: Aug. 26, 2004

(54) METHOD OF DESIGNING A MANUFACTURING ASSEMBLY LINE

(75) Inventors: Abid Ghuman, Bloomfield Hills, MI (US); James Lowe, Temperance, MI (US); Marsha Rosso, Royal Oak, MI (US); Kirk Sanborn, Shelby Twp., MI (US)

Correspondence Address: BROOKS KUSHMAN P.C./FGTL, 1000 TOWN CENTER, 22ND FLOOR, SOUTHFIELD, MI, 48075-1238, US

(73) Assignee: FORD MOTOR COMPANY, Dearborn, MI (US)

(21) Appl. No.: 10/708,817

(22) Filed: Mar. 26, 2004

Related U.S. Application Data
(62) Division of application No. 10/253,169, filed on Sep. 24, 2002.
(62) Division of application No. 10/253,686, filed on Sep. 24, 2002.

(51) Int. Cl. G06F 19/00

(52) U.S. Cl. 700/97

(57) ABSTRACT

A method of designing a manufacturing process line. A process is identified as a set of discrete steps. A subset of steps is assigned to one of a plurality of standardized work cells. The work cells include a standardized workpiece presenter and a standardized processing tool. Additional subsets of discrete steps are assigned to a standardized work cell until the design for the manufacturing process is completed.

### CROSS REFERENCE TO RELATED APPLICATIONS

This is a division of U.S. application Ser. No. 10/253,169, filed Sep. 24, 2002 and U.S. application Ser. No. 10/253,686, filed Sep. 24, 2002.

### BACKGROUND OF INVENTION

1. Field of the Invention

The present invention relates to a flexible system for designing a manufacturing line for complex body units, and more particularly to a method of developing a manufacturing process that standardizes the use of flexible systems utilized in manufacturing vehicle bodies.

2. Background and Summary of the Invention

The automobile industry is a capital intensive environment with extensive multinational competition and international company alliances. To be competitive, an automobile company must be in a position to offer a range of different vehicles on a global scale and be in a position to rapidly adjust to substantial fluctuations in demand. Automotive companies must be able to offer customers the ability to order a wide variety of different options and achieve increasingly high levels of quality while minimizing product cycles. Modern automobile manufacturing operations are extremely complicated. The efficiency of a multifaceted manufacturing operation is crucial to an automobile company's ability to sustain itself, even in tough economic times, and grow over time.

A fundamental requirement of any successful automobile manufacturing company is an ability to mass produce a variety of different vehicles very efficiently, year after year and model after model in a number of manufacturing plants that are located in one or more countries. It is desirable to both reduce the amount of capital investment required and provide greater manufacturing flexibility at the same time. It would be advantageous to shorten the time required to complete a model changeover and enable the same automobile manufacturing plant to rapidly switch over to produce different vehicle types. It would also be desirable to reuse a large percentage of existing manufacturing equipment when a different vehicle type or platform is to be manufactured. It is also important to leverage an automobile company's knowledge of component parts of a manufacturing system over time. Finally, it would be desirable to achieve these manufacturing efficiency benefits without requiring that all of the existing automobile plants in the company's manufacturing system undergo transformation at the same time.

These objectives aid in maintaining competitiveness of manufacturing operations that rely upon manufacturing systems developed as a paradigm and are replicated on a worldwide basis. Accordingly, a breakthrough in operational efficiency is desired that will change the competitive economics of complicated manufacturing systems.

During the twentieth century, there have been numerous improvements to the assembly line techniques introduced by Henry Ford and the Ford Motor Company. Robots are now used to weld stamped body panels together with considerable precision and speed. While it is possible to add flexibility to robot paths and reach to weld different automobile body styles on a common or similar vehicle platform, the flexibility provided by such adjustments is limited.

Thus, it is an objective of the present invention to provide a system and method of manufacturing complex body units that is flexible and well suited to implementation by a large automotive vehicle manufacturing operation.

It is another objective of the present invention to provide a flexible system and method of manufacture that enables rapid changeovers between automotive vehicle bodies of different types that may be built on different platforms using standardized assembly equipment.

It is an additional objective of the present invention to provide a flexible system and method of manufacture that is capable of transforming supplier relationships, engineering processes, and the fundamental economics of automobile manufacturing.

It is a further objective of the present invention to provide a flexible system and method of manufacture that will substantially decrease training and maintenance costs.

To achieve the foregoing objectives, a flexible system and method of manufacturing is provided that utilizes a sequence of manufacturing steps and a set of manufacturing station templates for manufacturing a plurality of different types of complex body units.

Further advantages and features of the present invention will be better understood in view of the following detailed description of several embodiments of the invention.

### BRIEF DESCRIPTION OF DRAWINGS

FIG. 1 is a flowchart of a method of designing a manufacturing system according to the present invention.

FIGS. 2-18 are perspective views of standardized work cells that are arranged following templates that are combined to create a complete manufacturing system.

FIG. 19 is a schematic of a process line having a plurality of templates.

FIGS. 20-22 are templates for making a dash panel, a cowl top, and a front structure, respectively.

### DETAILED DESCRIPTION

Vehicle manufacturing systems generally comprise a process line for assembling the body of an automotive vehicle. Metal components of the body assembly for an automotive vehicle are created in a metal stamping facility. In some instances, metal stamping facilities are located next to a vehicle assembly plant. However, most stamping facilities are remote from assembly facilities which necessitates that the stamped metal workpieces be shipped by rail or truck to an assembly plant.

Upon arrival at the assembly plant, stamped workpieces are delivered to the body shop of the assembly facility. In the body shop, the shell of the vehicle is assembled on a weld processing line. After the shell of the vehicle is assembled on the weld processing line, the body is delivered to the paint shop of the assembly plant where the body is painted. The prime coat applied to the body shell is white and the term “body-in-white” is often used to refer to the body assembly.

After the prime coat is applied, the body-in-white is color-coated and typically multiple clear coats of paint are applied over the color coat. The painted body is later married with chassis components, such as a frame, and a powertrain. The powertrain includes the engine, the transmission and drive shafts. After the body is married to the frame, it is referred to as a “body-on-frame.” The body-on-frame is then delivered to the trim area of the assembly plant where the interior components such as seating are added to the vehicle.

The flexible method of designing a manufacturing assembly line of the present invention is described in the context of a manufacturing facility wherein components are primarily joined together by welding processes. The process tooling can, in some instances, position two separate workpieces that are welded together by a welding robot. In other configurations, a fixture holds just one workpiece for welding or other various metal working operations. For example, these operations can include spot welding or weld finishing operations. In still other operations, a fixture positions a workpiece or a subassembly for sealant or adhesive application operations. The process line produces an automotive vehicle from a plurality of subassemblies that are generated from various combinations of workpieces. The process line is comprised of a plurality of standardized task stations. To enjoy the greatest benefit from the present invention, the number of different task stations is limited.

Each of the task stations in a given process line has a workpiece presenter and a processing tool. The workpiece presenter may have a selectively moveable platform. A tooling plate may be precisely located on the platform in a repeatable manner. The discrete process steps for producing a given subassembly of a vehicle body are determined. A set of task stations are defined and combined in what is referred to as a template. A combination of at least two or more templates is organized in a predetermined manner to form a process line on which the complete body assembly is fabricated.

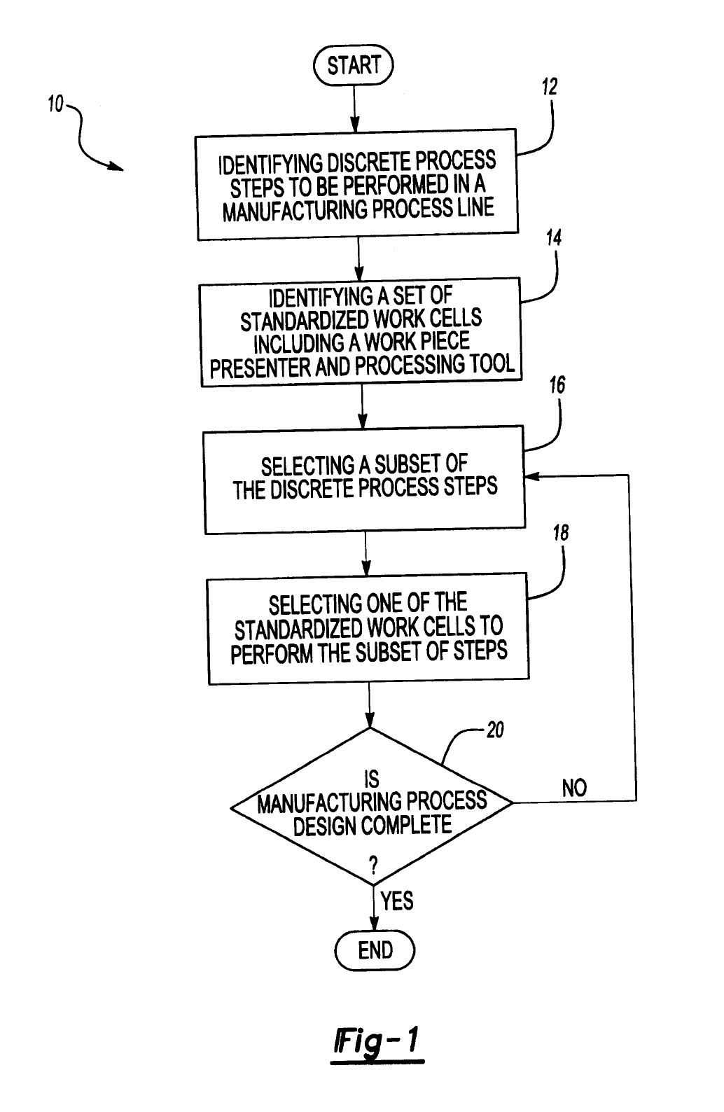

Referring to FIG. 1, a manufacturing engineering design process for designing a process line is illustrated by a flowchart. According to the process, the first step is identifying, at 12, discrete process steps that are to be performed in a manufacturing process line. Next, at 14, a set of standardized work cells are identified including a workpiece presenter and a processing tool. At 16, the step of selecting a subset of the discrete processing steps is performed. Then selecting, at 18, one of the standardized work cells to perform the subset of steps. At 20, a decision is made as to whether or not the manufacturing process is complete. If all of the steps have not been performed, the method returns to the selecting step at 16. This may be continued until the entire manufacturing process design is completed.

A flexible manufacturing system according to the present invention preferably utilizes sixteen standardized flexible work cells.

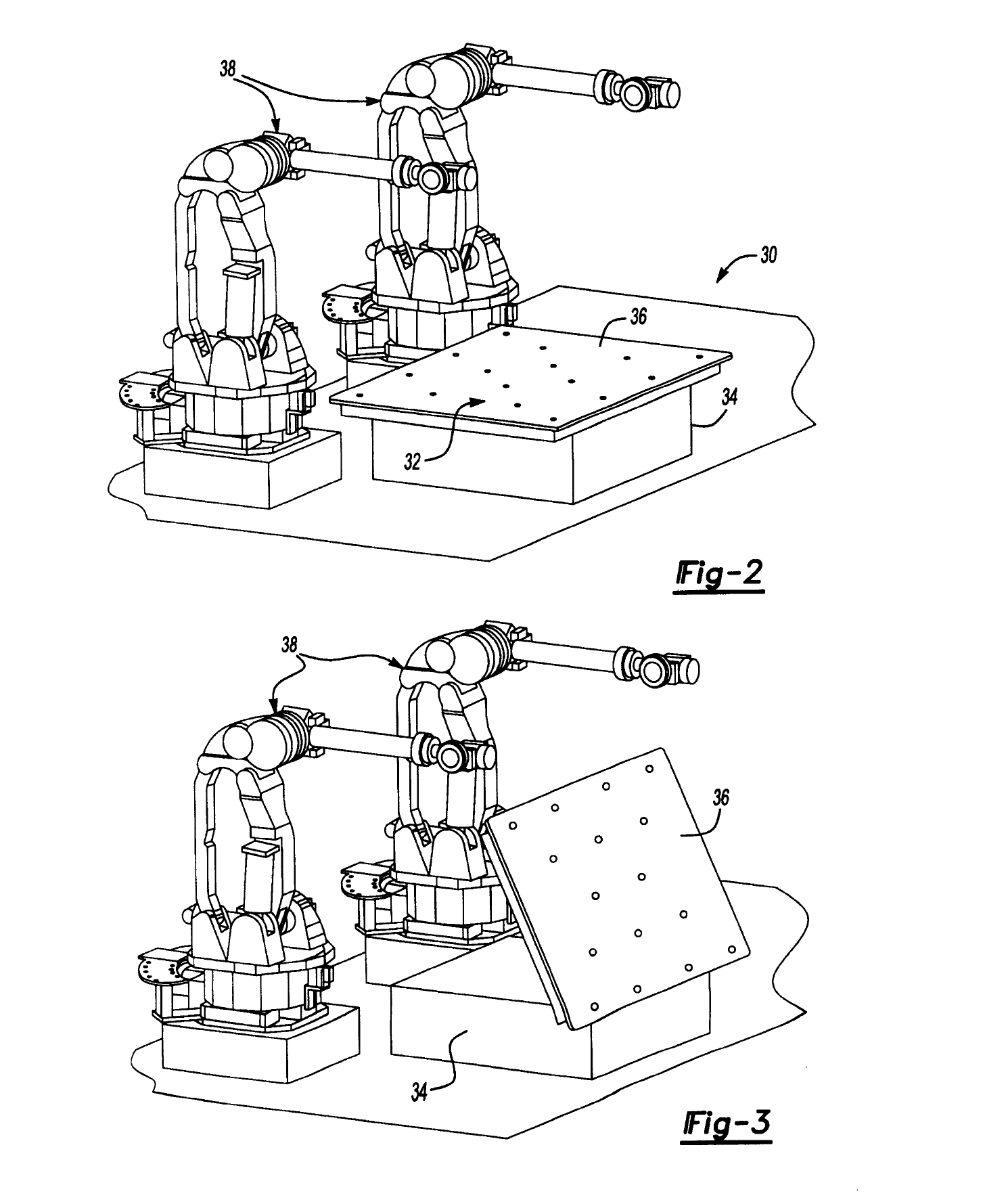

Referring now to FIG. 2, work cell one 30 comprises a tabletop fixture 32, having tilt platform 34 for mounting a tooling plate 36, and at least one robot 38. Tilt platform 34 accommodates tooling plate 36 by tilting from the horizontal to a convenient easel-like angle as shown in FIG. 3. The tilting feature allows an operator, whether human or otherwise, to reach fixtures (not shown) mounted upon tooling plate 36 so as to mount a workpiece when tilt platform 34 and tooling plate 36 are in the tilted position. The tooling plate 36 and tilt platform 34 may be returned to the horizontal position for welding or sealer application, or other operations performed by one or more robots 38. If welding is desired, the robots 38 may be equipped with a weld gun 40. The fixture shown in FIGS. 2 and 3 may preferably accommodate tooling plates ranging in size from about 900×1200 mm to about 1800×2400 mm.

The robot 38 employed in work cell one 30 (FIGS. 2 and 3) may be a completely robotic welder or otherwise. Other units that may be used with work cell one 30 include robotic material handling devices utilizing a custom design gripper to remove a part assembly from a fixture mounted upon tooling plate 36, or a combined robotic material handler and welder combination. As an option, the work envelopes of the robots 38 may be increased by using a seventh-axis slide.

Work cell two (FIG. 4) is a hexapod manipulator work cell 42. As used herein, the term “hexapod manipulator” means a compact robot having six electrically driven, computer-operated ball screws 44 that are used to hold and position a workpiece. Here, hexapod manipulator 46 uses clamps 48 and pins 50 to precisely hold a workpiece as it is welded by a pedestal welding machine 52. Unlike welders attached as an end effector to a movable robot, the pedestal welder 52 does not move; rather the workpiece must be brought to the pedestal welder 52. Pedestal welder 52 may be supplemented or even supplanted by a projection weld gun unit (not shown) which includes a transformer, cables and a weld controller, with hexapod manipulator 46 placing the workpiece into the weld gun unit of pedestal welder 52. As yet other alternatives for work cell two, a sealer dispensing unit (not shown) may be used to place sealer on certain surfaces of a workpiece while the workpiece is positioned by hexapod manipulator 46. Finally, a nut feeder with a hopper and a feeder tube (not shown) may be used to supply nuts which can be welded or mechanically fastened in place upon the workpiece.

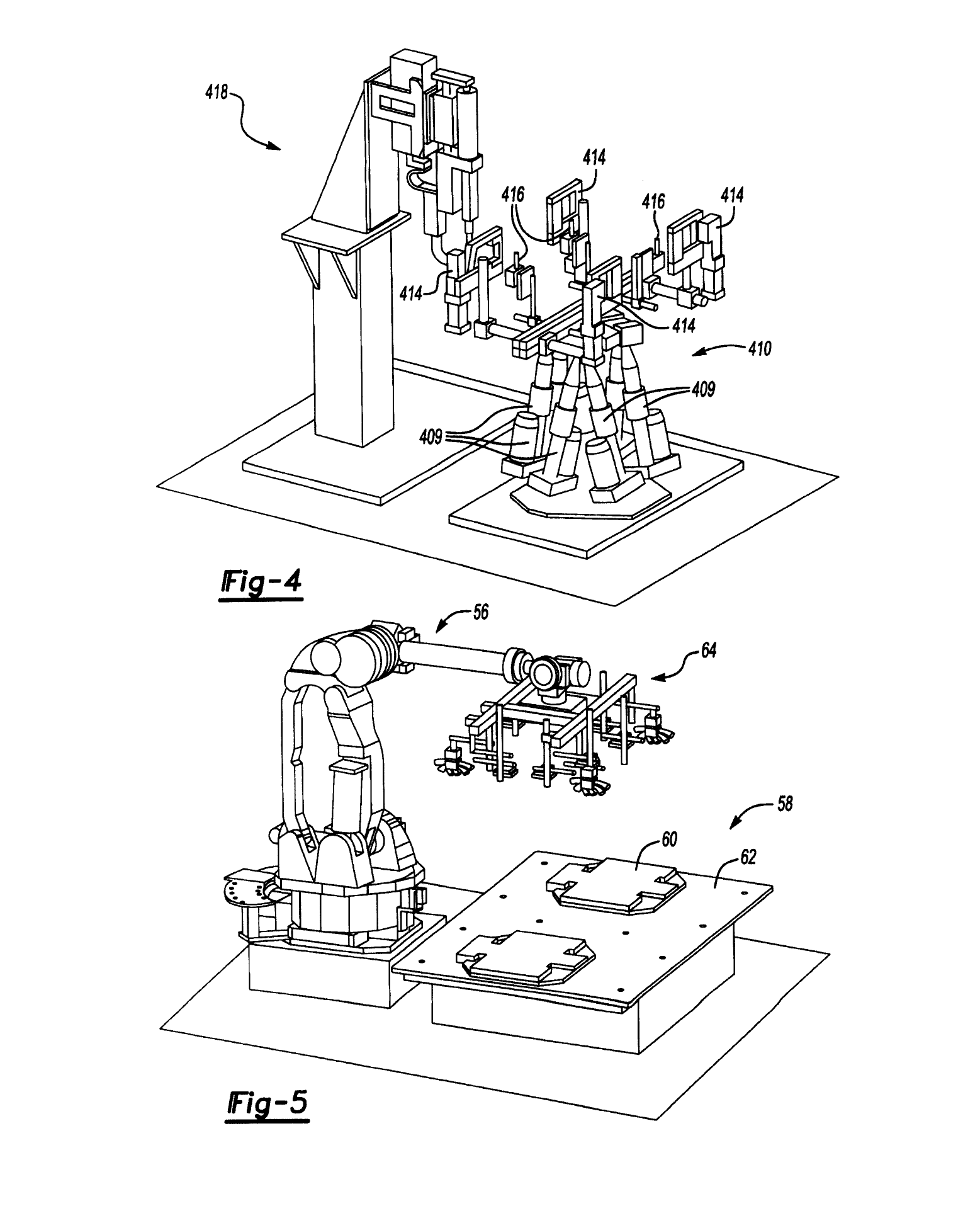

Work cell three (FIG. 5) is a pedestal welding work cell 56 having a robot 58 for positioning a workpiece. When work cell three is employed, an operator, human or otherwise, positions the workpiece parts in fixtures 60 attached to tooling plate 62, which is mounted at bench height. Then, end effector 64 comprising a gripper, and robot 58 will pick up the parts from tooling plate 62 and move them either to a pedestal welder of the type shown in FIG. 4 for work cell two, or a projection welder or a sealer dispenser (not shown).

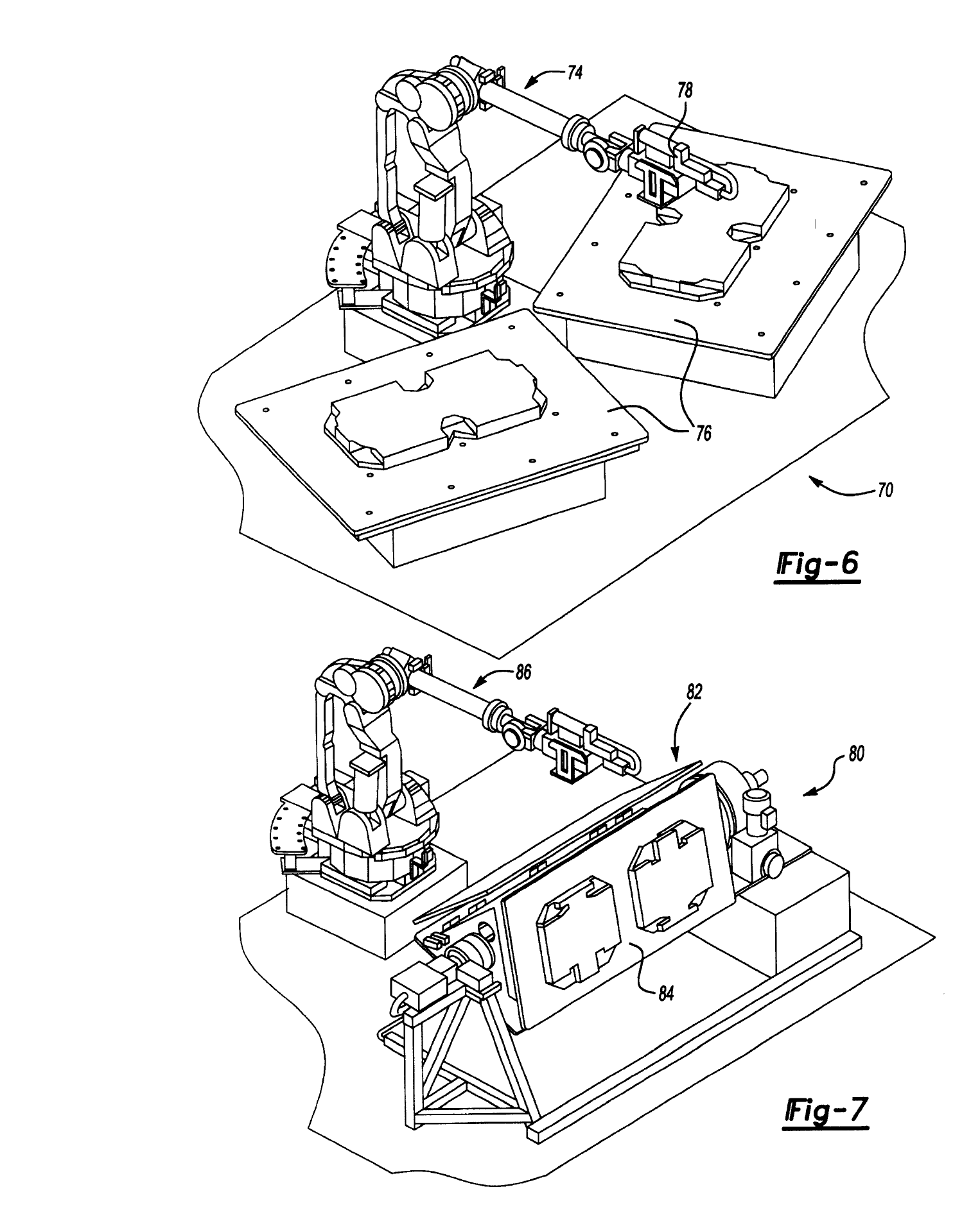

Work cell four (FIG. 6) is a dual station 70 having a seventh-axis slide to increase the work envelope of robot 74. As shown, work cell four may have dual tooling plates 76 and may utilize either a shared robot 74, or multiple robots. A variety of tooling plates may be used, with several different sizes extending from approximately 900×1200 mm to the largest at about 1800×2400 mm. Welding gun 78 handles the task of supplying the localized current and electrodes needed for a spot or fusion welding operation.

As described above, robotic welding units or material handler robots or material and welder combination robots may be employed with this work cell. Also, the tooling plate orientation may be zero° or flat, 30° angled or 70° angled. An important point here is that interchangeable tooling plates allow repeatable and precise positioning of parts.

Work cell five (FIG. 7) is a trunnion station 80 that includes a three-sided trunnion fixture 82, which may be equipped with three tooling plates 84 and which rotates about a horizontal axis so as to present workpieces to welding robot 86.

A two-sided trunnion 88 may alternatively be provided that rotates about a horizontal axis. The two-sided trunnion accepts a standard tooling plate that may be a larger size than the tooling plates employed with the three-sided trunnion fixture 82. The two-sided trunnion may also function as a workpiece presenter, preferably for a welding or sealing operation.

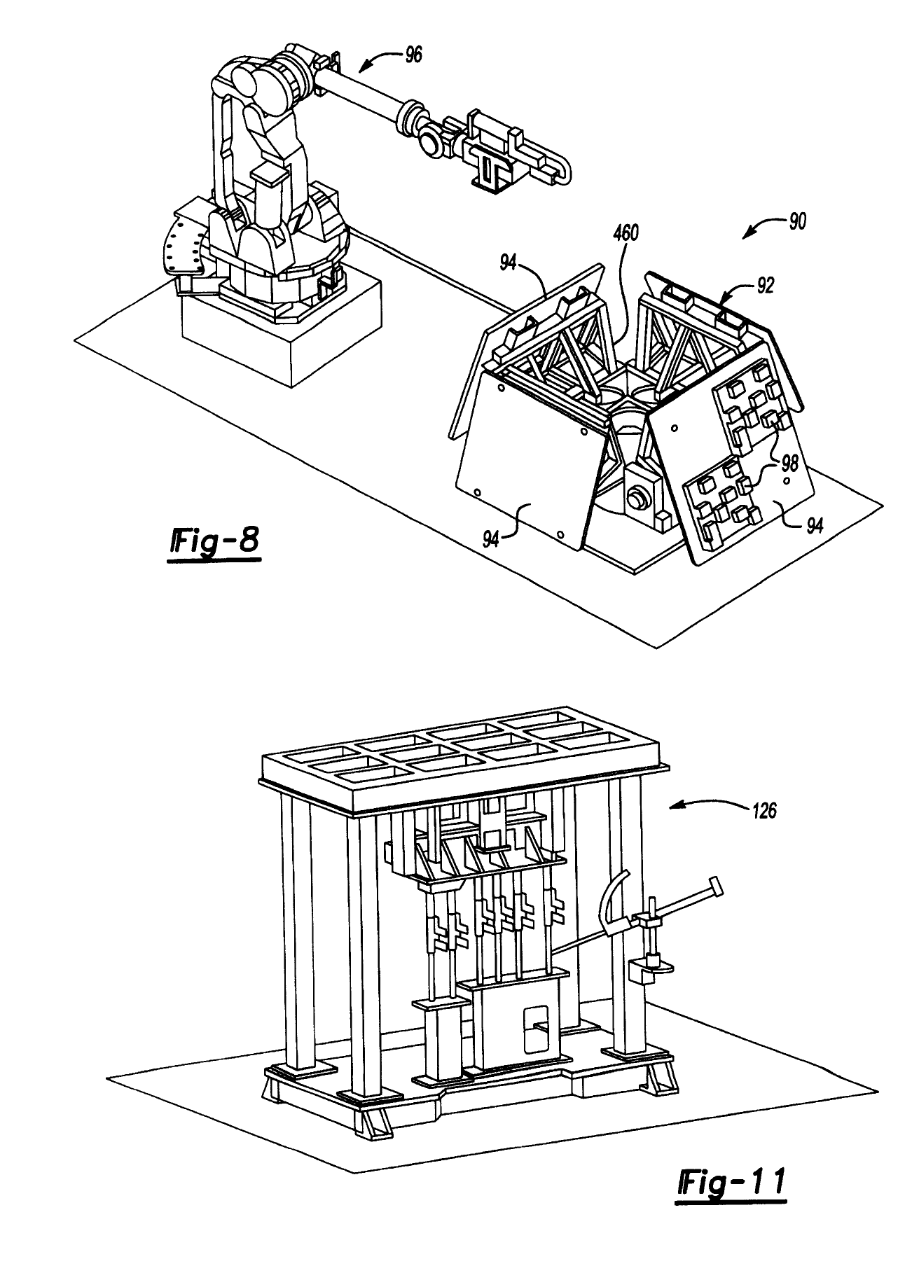

Work cell six (FIG. 8) is a four-sided turntable fixture station 90 having a turntable fixture 92 having four positions for mounting four standard tooling plates 94. Turntable fixture 92 may be constructed in approximately three different capacity ranges from 6500 lbs. to 20,500 lbs. total capacity. This largest turntable could accommodate tooling plates up to 1800×2400 mm.

As shown in FIG. 8, robotic welding could be accomplished by at least one welding robot 96. Although multiple tooling fixture modules 98 are shown as being attached to tooling plates 94, those skilled in the art will appreciate in view of this disclosure that other types of tooling arrangements could be selected. Robotic material handling is another option as is a combination material handler and welder (not shown). Finally, a seventh-axis slide (not shown) may be used to increase the welding robot's work envelope.

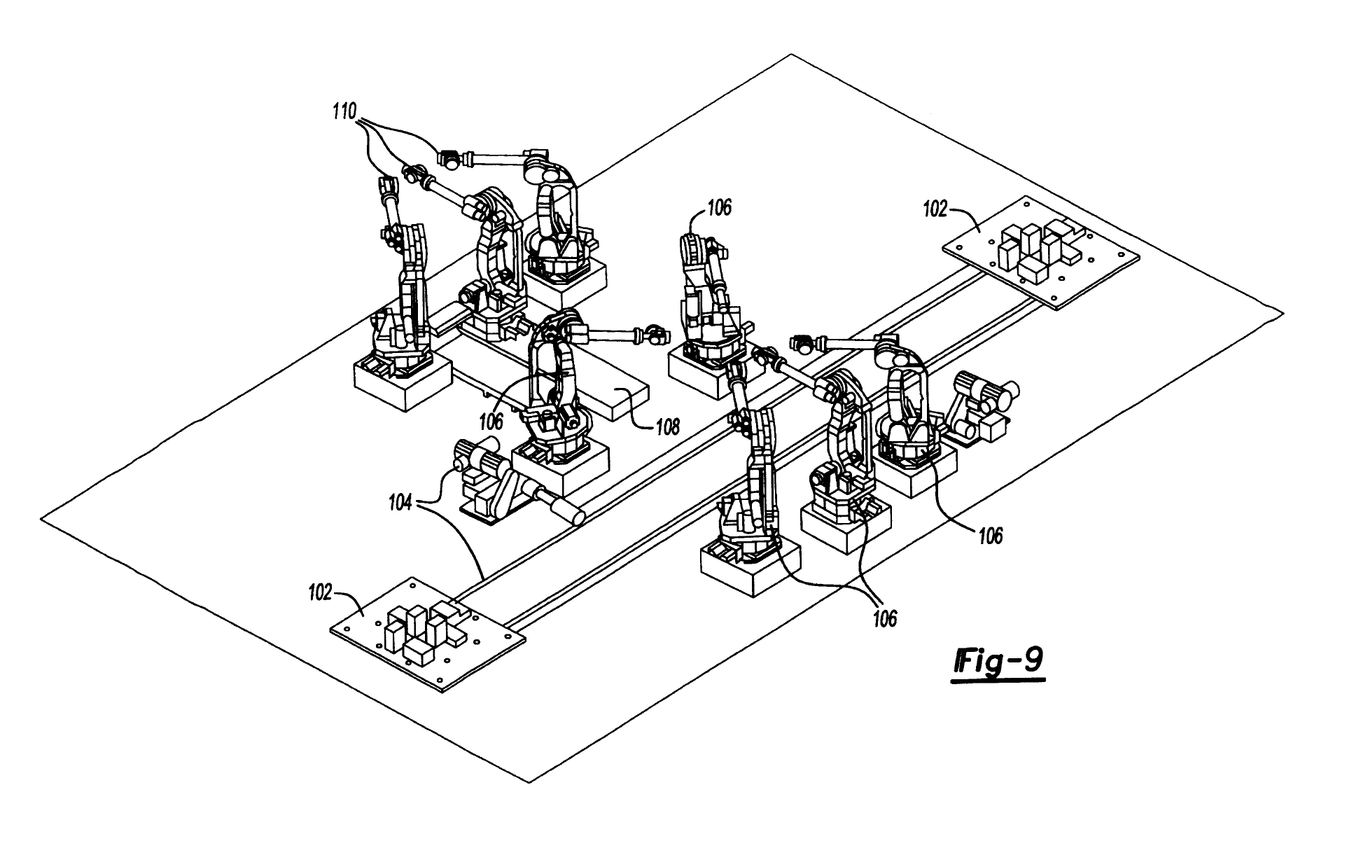

Work cell seven (FIG. 9) is an indexing tooling plate work cell 100 having two tooling plates 102 which are independently controlled and which are preferably loaded by a human operator. Tooling plates 102 are mounted to indexing shuttle mechanism 104 which indexes the loaded tooling plates and attached workpieces into a welding or sealing zone. Up to five welding or sealing or machining robots 106 or other types of robot may be used with work cell seven. Because shuttle 104 travels perpendicular to the material system flow, operators may load parts from three sides of the fixture and one additional slide mechanism 108 and material handling robots 110 may be accommodated on the opposing side. Work cell seven may be used with robotic welders or robotic material handlers or combination robotic material handler and welder robots, as previously described.

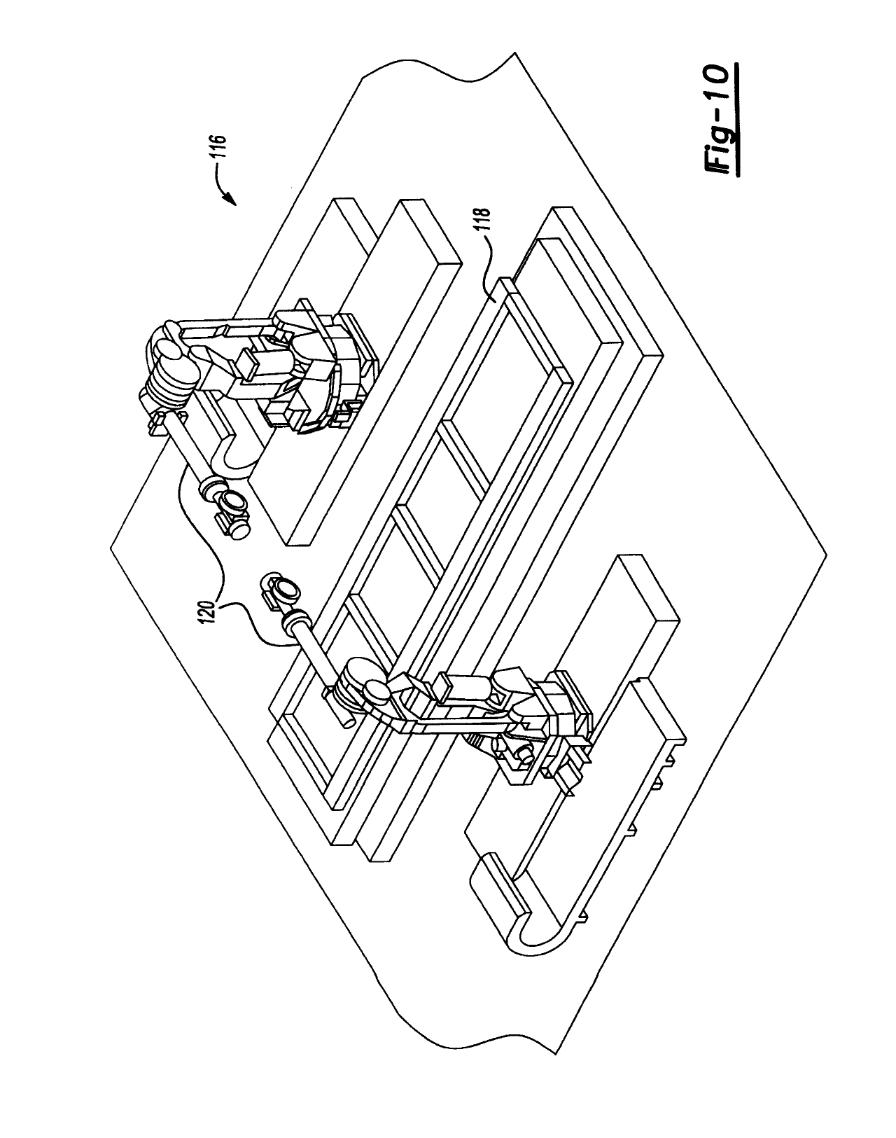

Work cell eight (FIG. 10) is a laser welding work cell 116 equipped for receiving a very large tooling plate (not shown) by means of roller bed 118. This large tooling plate is often termed a “pallet” in the trade. Although two laser welding robots 120 are shown, additional robots, or even a single robot, could be used with this work cell. Additional equipment that could be employed with work cell eight according to the needs of someone wishing to practice the present invention could include a robot vision system to track a laser robot, or a seventh-axis slide to increase the robot's work envelope.

Work cell nine (FIG. 11) includes a press welding fixture 126 that allows many spot welds to be made in a short period of time. This type of fixture has been in use for many years in automotive assembly plant body shops but has not been part of a standardized work cell system according to the present invention.

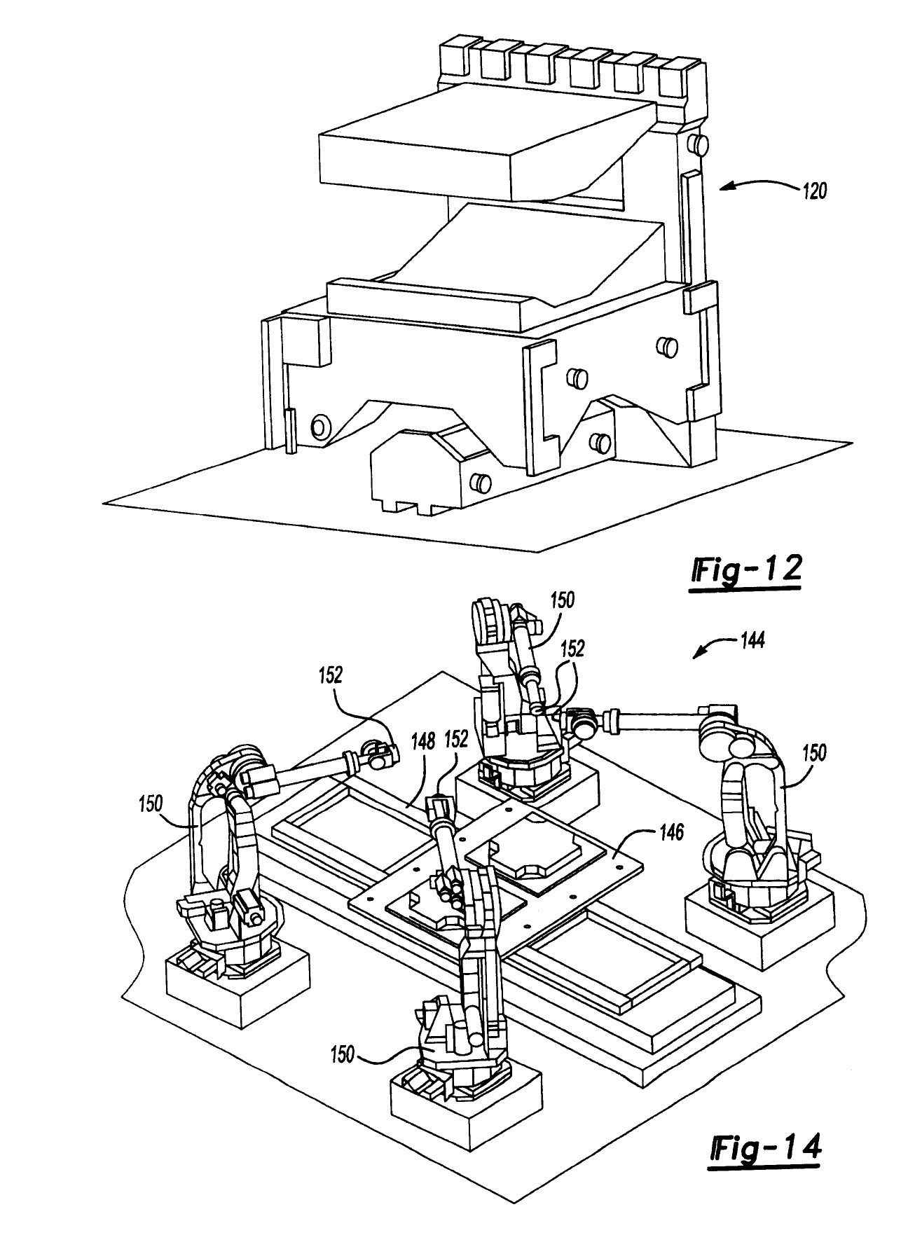

Work cell ten (FIG. 12) is a schematic representation of a hem, clinch or pierce work cell 128 which may include either a conventional hemmer or a clincher or a piercer. A robotic material handler may be used with this work cell to remove processed assemblies or subassemblies.

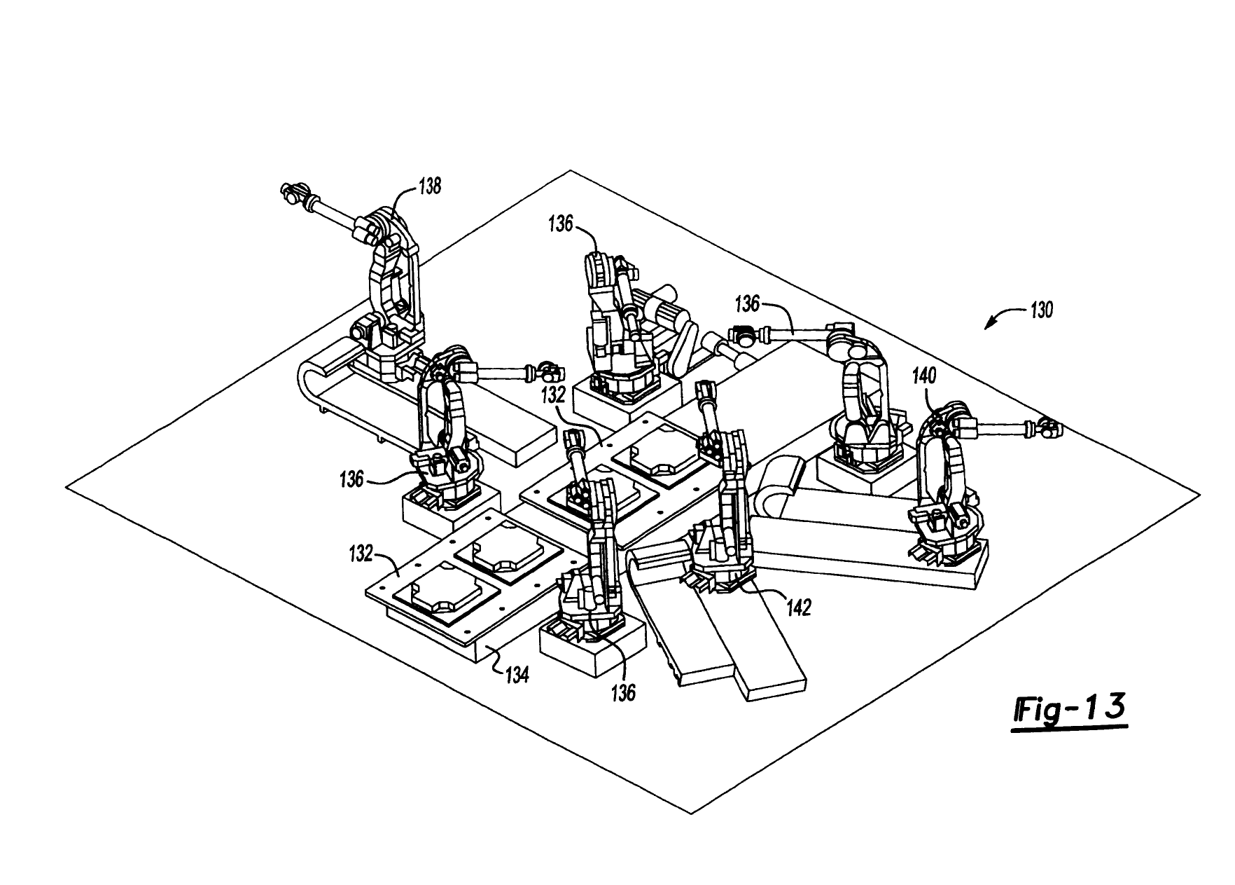

Work cell eleven (FIG. 13) is a double sliding tool plate station 130 and multiple robots. Tooling plates 132 are mounted on common indexing shuttle 134. The robots include four robots 136 for welding and three slide-mounted robots 138, 140, and 142 for handling material. Robots 140 and 142 allow workpieces to be placed on either one of tool plates 132 depending on the mix of parts needed at work cell eleven. It should be noted that the slides for robots 140 and 142 are neither parallel to each other nor perpendicular to the center axis of indexing shuttle 134. Optionally, robots 136 may be either welding robots or could be other types of robots such as sealing or adhesive dispensing units.

Work cell eleven provides a very high level of flexibility because the diverging arrangement of the slide mounts for material handling robots 140 and 142 allow for large, extensive feeder stations (not shown) which may accommodate a very wide range of component parts and subassemblies. This flexibility is extremely useful in conjunction with the capability to process multiple parts with tooling plates 132.

Work cell twelve (FIG. 14) is a vision work cell 144 that has provisions for receiving pallet 146 on roller bed 148. Vision work cell 144 features optical measuring devices and fixtures for performing inspections using four robots 150 and cameras 152 with associated calibration equipment. Optionally, a smaller or larger number of cameras and robots could be employed with this work cell.

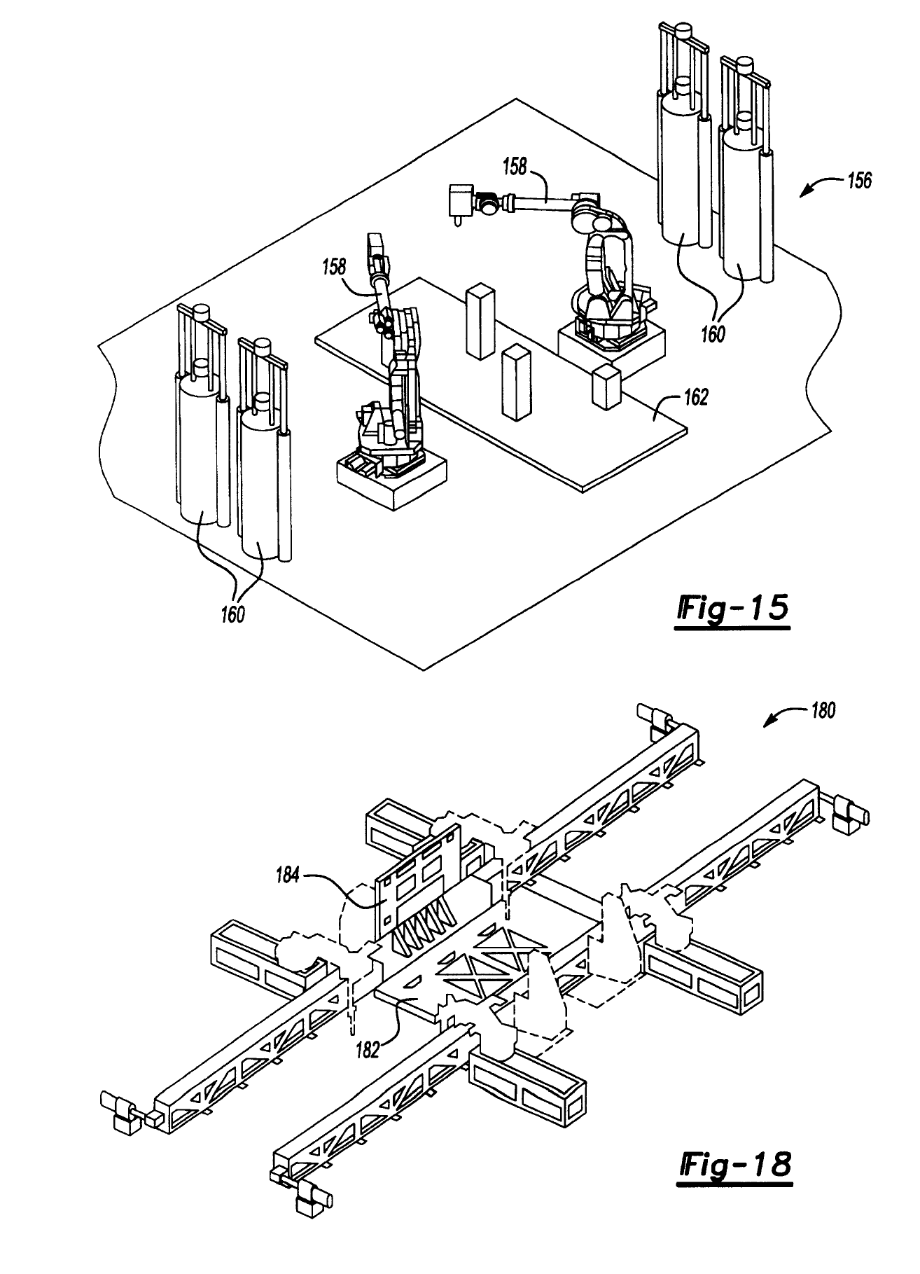

Work cell thirteen (FIG. 15) is a sealer applying work cell 156 having two robots 158 which may apply adhesive, sealer, or mastic stored in tanks 160. Although a larger tooling plate 162 is illustrated in FIG. 15, as with other work cells, either a smaller tooling plate or a large pallet could be employed for handling workpieces. If a pallet is used, work cell thirteen could have a roller bed for accommodating the pallet system.

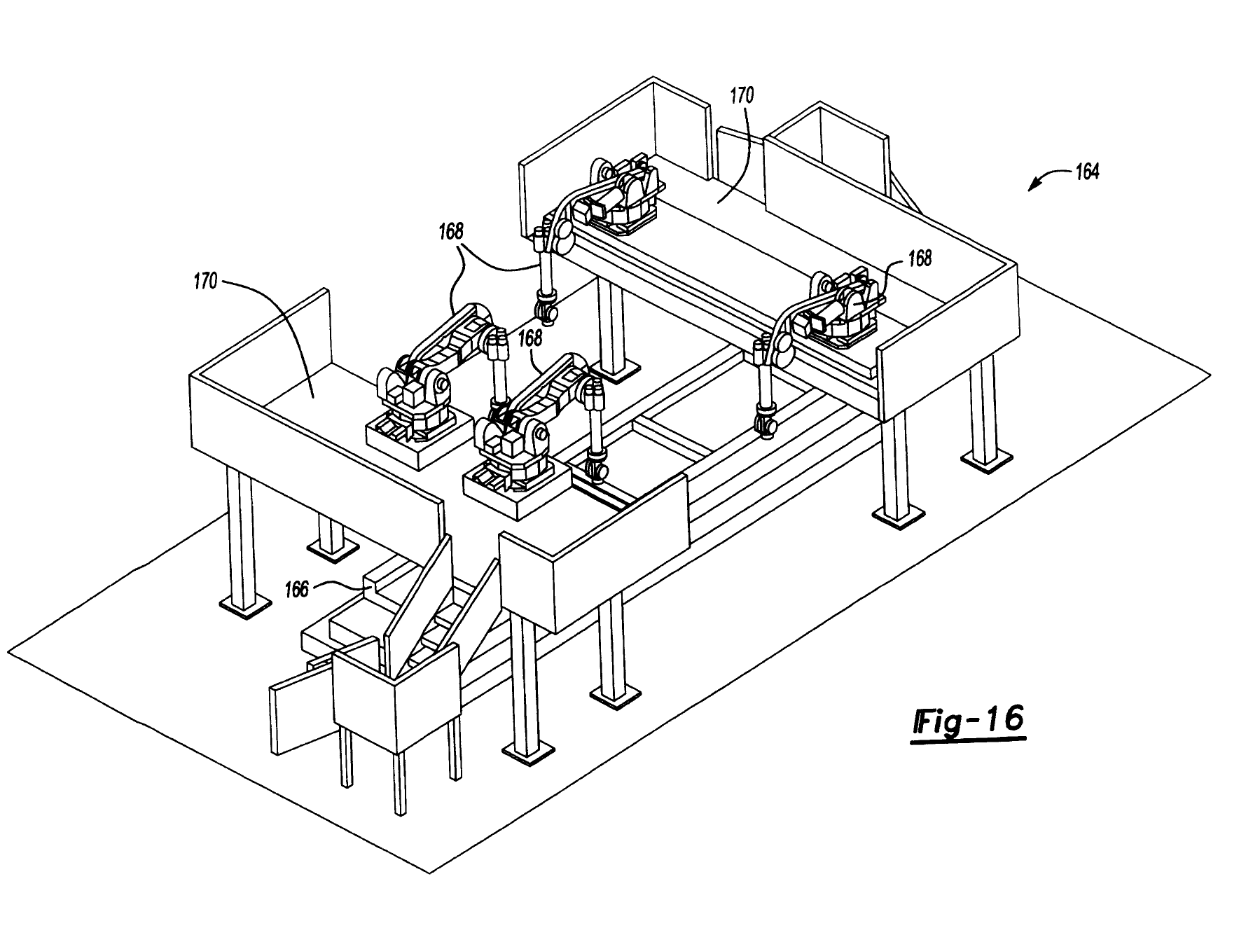

Work cell fourteen (FIG. 16) is a dual shuttling tooling plate welding work cell 164 mounted upon shuttle drive 166, and four robots 168 mounted on balconies 170 which allow robots 168 to reach down to operate on workpieces carried upon the tooling plates as they move back and forth under the robots 168. The sliding tooling plates provide model mix capability. In other words, different types of vehicles may be handled without the need for tooling changeover.

Work cell fifteen (FIG. 17) is a large assembly welding work cell 174 used for large assemblies and includes roller bed 176 for accommodating a pallet (not shown) and may utilize not only the six illustrated robots 178, but also robotic welders or sealing or adhesive application robots. Alternatively, a smaller number of weldbots (welding robots) could be employed, either alone or with adhesive or sealer applying robots.

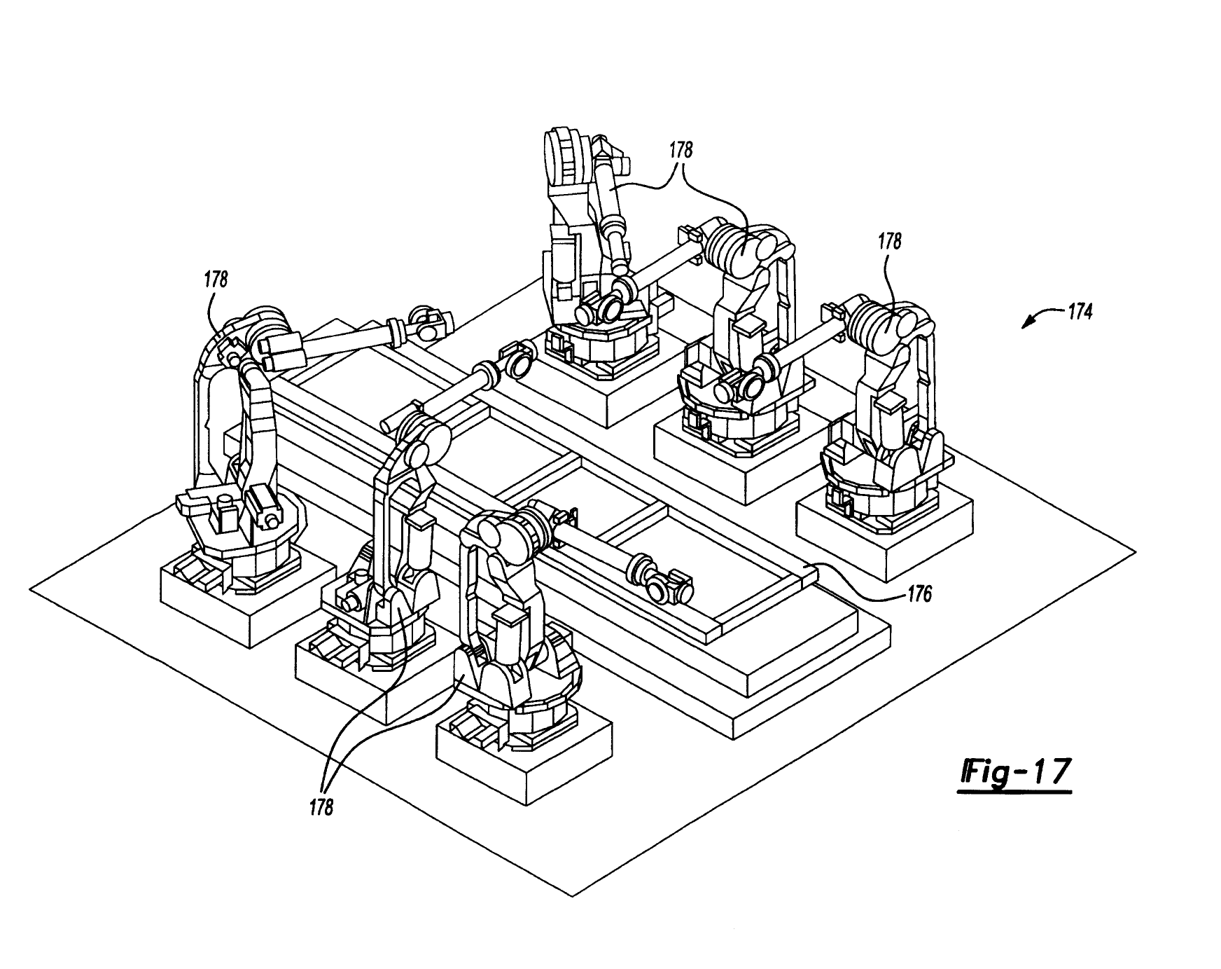

Work cell sixteen (FIG. 18) is schematic representation of a framer station 180 which is used to join a vehicle body side to an underbody. In use, the underbody would be mounted upon a pallet and brought into a roller bed 182 that is incorporated in work cell sixteen. Gate fixture 184 is used to mate the body side with the underbody while the underbody is on the pallet, to permit welding of the body side and underbody. If desired, work cell sixteen equipment may be augmented to include an overhead balcony holding additional robots or an indexing unit and extra gate so as to accommodate other body configurations.

The flexible manufacturing system also has standardized transfer work cells to move workpieces and subassemblies between various templates and operational work cells.

As mentioned previously, the process line is formed by a plurality of templates that are combined in a predetermined alignment to form the process line. The process line can be made flexible in different ways. First, the process line can be made flexible so that a first set of different subassemblies can be manufactured on the process line which differs from one another. These different subassemblies can be manufactured simultaneously due to the presence on the process line of workpiece presenters which have a tooling plate for each separate subassembly. In rare instances where the process line is dedicated to one type of vehicle, the entire process line can be quickly retooled by changing the appropriate tooling plates and reprogramming the robotic operators. However, in most instances, flexibility is chiefly accomplished by having workpiece presenters with tooling plates for all types of subassemblies desired.

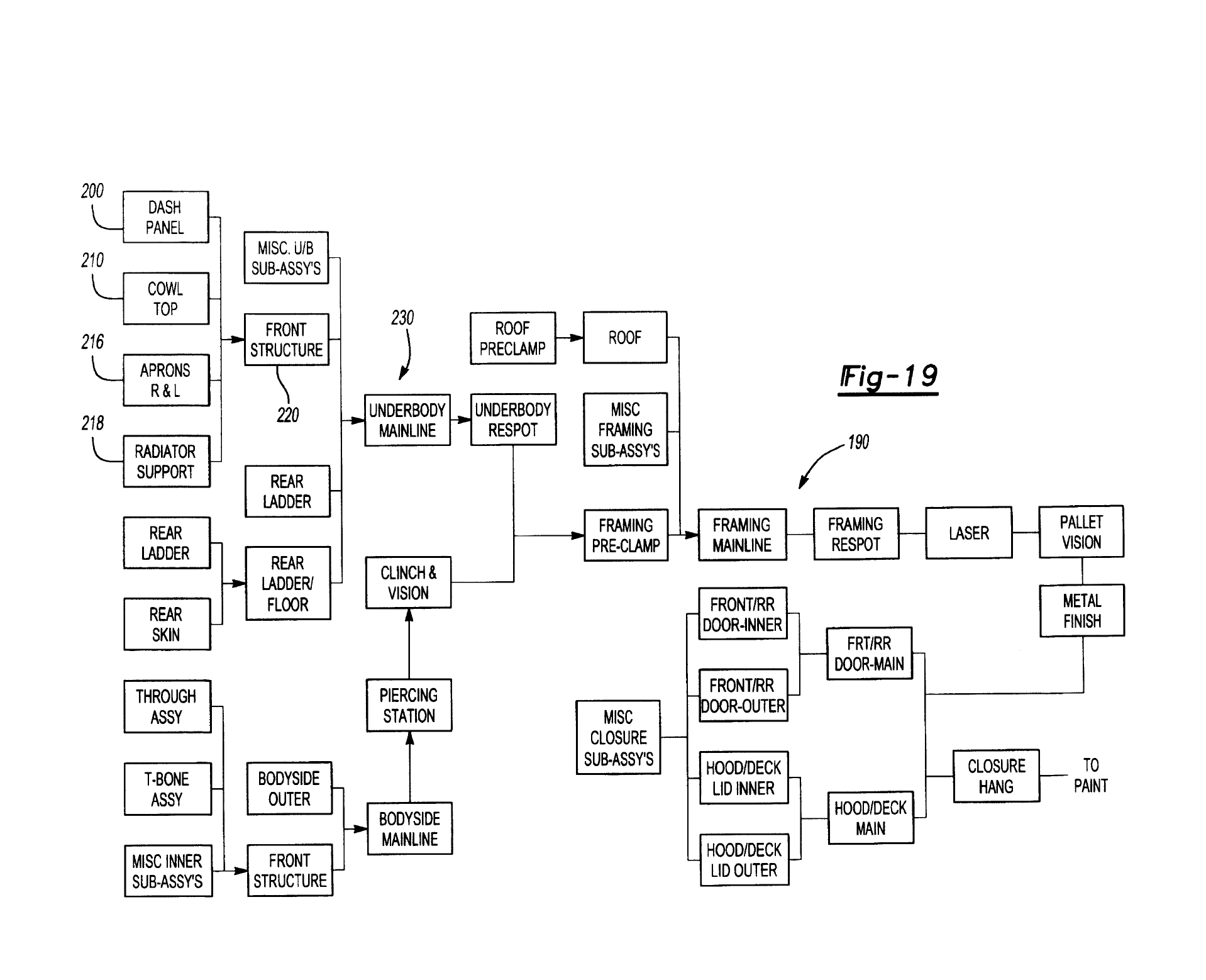

Referring to FIG. 19, an example of a flexible process line is shown. In this embodiment, the process line 190 is for assembling the body of a car. Similar process lines may be created for other vehicle types, such as trucks. For instance, in the case of a truck body assembly line, one or more templates for making a bed portion may be incorporated while templates for making a trunk portion become unnecessary.

The process line 190 is made up of a number of templates, represented by rectangular boxes. The arrowed lines connecting the templates represent the flow of components or subassemblies from one template to another.

By way of illustration, a set of templates utilized to make a front structure of a car will now be described. More specifically, a dash panel, a cowl top, left and right aprons, and a radiator support are provided by a dash panel template 200, a cowl top template 210, an apron template 216, and a radiator support template 218, respectively. The front structure is fabricated using these components/subassemblies with a front structure template 220.

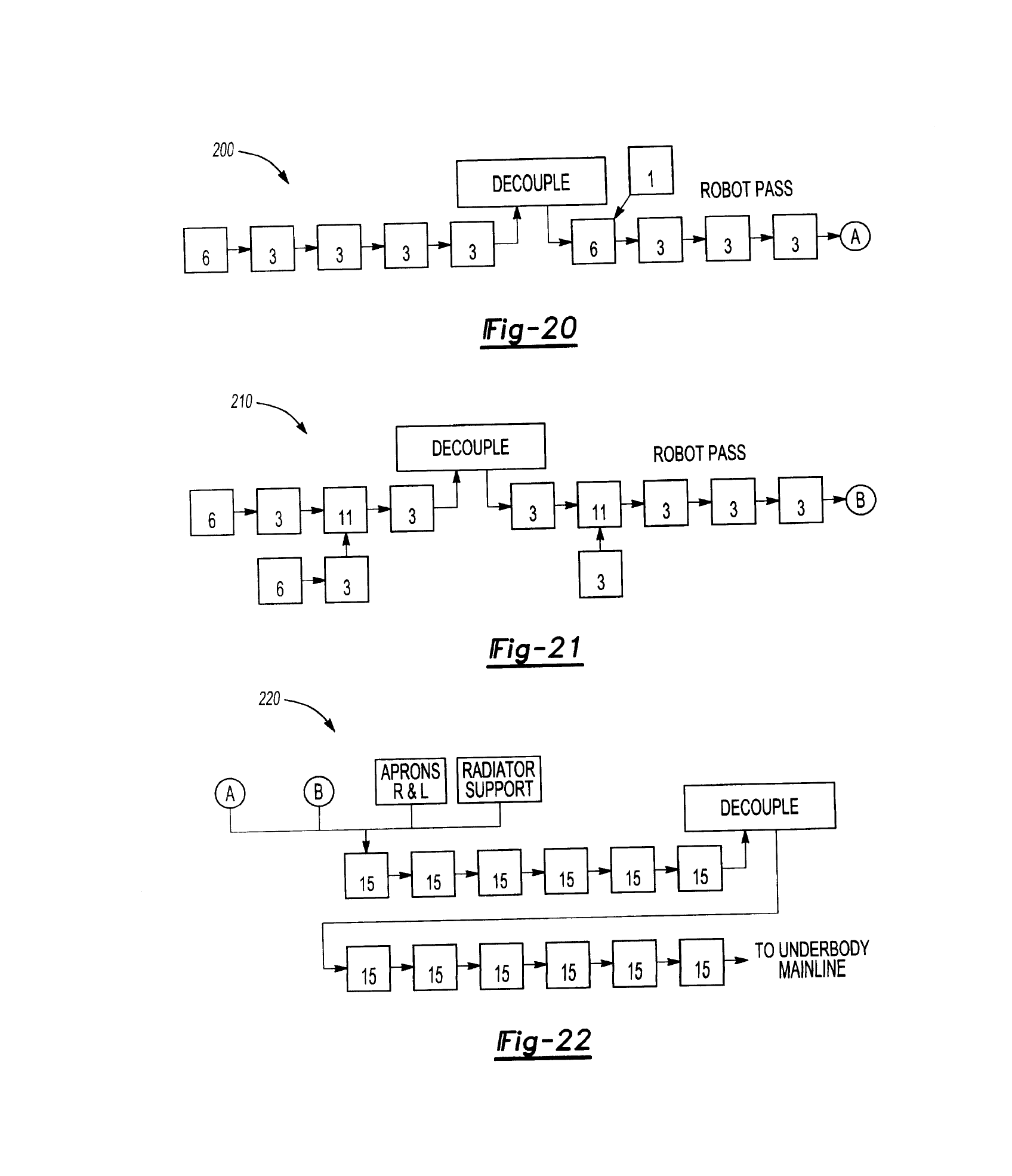

Referring to FIGS. 20, 21 and 22, the dash panel template, cowl top template 210, and front structure template 220 are described in more detail. Each template 200, 210, 220 is made up of a number of work cells. The flow of material between work cells is represented by arrowed lines. Optionally, each template may employ one or more decoupling stations to provide a buffer between stations to improve material flow.

Referring to FIG. 20, a template for making a dash panel is shown. Specifically, the dash panel template 200 includes one tabletop fixture (work cell 1), seven pedestal welding work cells (work cell 3), and two four-sided turntable fixture stations (work cell 6). The dash panel is made by processing material through a series of work cells. For example, the subassembly made at the first four-sided turntable fixture station (shown at the left of FIG. 20) is subsequently processed by four pedestal welding work cells. The pedestal welding stations make one or more welds to the material received from the previous work cell. After passing through a decoupling station, the second four-sided turntable fixture processes material received from the fourth pedestal welding station and from the tabletop fixture. Three pedestal welding stations then perform operations to complete the dash panel.

Referring to FIG. 21, a template for making a cowl top is shown. Specifically, the cowl top template 210 includes eight pedestal welding work cells (work cell 3), two four-sided turntable fixture stations (work cell 6), and two double sliding tool plate stations (work cell 11). A decoupling station is disposed between two consecutive pedestal welding work cells. Similar to FIG. 20, material flows through the work cells in sequence to fabricate a cowl top.

Referring to FIG. 22, a template for making a front structure is shown. The front structure template 220 includes twelve large assembly welding work cells (work cell 15). The material from the dash panel template 200 and cowl top template 210 is designated by circled letters A and B, respectively. A radiator support and aprons are also provided. These components/subassemblies are processed by the large assembly welding work cells. For example, the components/subassemblies may be attached to each other by executing a plurality of welds, culminating in a front structure assembly. The front structure assembly may then be provided to an underbody mainline template 230 for additional processing.

While the best mode for carrying out the invention has been described in detail, those familiar with the art to which this invention relates will recognize various alternative designs and embodiments for practicing the invention as defined by the following claims.

1. A method of designing a manufacturing process line, comprising:
identifying a manufacturing process comprising a set of discrete steps to be performed on at least one workpiece;
identifying a plurality of standardized work cells, each work cell having at least one standardized workpiece presenter that supports the workpiece in a predefined spacial orientation, and at least one standardized processing tool;
selecting a subset of the set of discrete steps to be performed at a work cell and selecting the standardized work cell for performing the subset of steps; and
repeating the selecting step for additional subsets of steps to the plurality of work cells until all of the discrete steps are assigned to one of the plurality of work cells.

2. The method of claim 1 wherein a plurality of manufacturing process lines are identified as templates.

3. The method of claim 2 wherein the manufacturing process line is completely designed by specifying a plurality of templates in a defined sequence.

4. The method of claim 1 wherein the workpiece presenter and processing tool are interrelated with an integrated standard control system.

5. The method of claim 1 wherein a first work cell comprises the standardized workpiece presenter comprising a table top fixture having a tilt platform and the predefined processing tool is selected from the group consisting essentially of a welder and a gripper.

6. The method of claim 5 wherein a second work cell comprises the standardized workpiece presenter comprising a hexapod manipulator having six computer controlled ball screws and the processing tool is selected from the group consisting essentially of a pedestal welder, a sealant dispensing unit, and a projection weld gun.

7. The method of claim 6 wherein a third work cell comprises the standardized workpiece presenter comprising a pedestal welding work cell having a robotic arm for picking up parts from a fixture and moving the parts to the processing tool selected from the group consisting essentially of a pedestal welder, a sealant dispensing unit, and a projection weld gun.

8. The method of claim 7 wherein a fourth work cell comprises the standardized workpiece presenter comprising a dual station having a seventh axis slide and the processing tool is a welding gun.

9. The method of claim 8 wherein a fifth work cell comprises the standardized workpiece presenter comprising a multiple sided trunnion fixture having a plurality of fixtures for a plurality of workpieces that are rotated about a horizontal axis and the processing tool is selected from the group consisting essentially of a welding robot and a sealant applicator.

10. The method of claim 9 wherein a sixth work cell comprises the standardized workpiece presenter comprising a multiple sided turntable fixture having a plurality of fixtures for a plurality of workpieces that are rotated about vertical axis and the processing tool is a robotic welder.

11. The method of claim 10 wherein a seventh work cell comprises the standardized workpiece presenter comprising an indexing shuttle having at least two independently controlled fixtures for at least two workpieces and the processing tool is selected from the group consisting essentially of a welding robot and a sealant applicator.

12. The method of claim 11 wherein an eighth work cell comprises the standardized workpiece presenter comprising a roller bed for supporting a pallet that supports a fixture for a workpiece and the processing tool is a laser welding robot.

13. The method of claim 12 wherein the ninth work cell comprises the standardized workpiece presenter comprising a fixture in a press welding fixture and the processing tool is a press welding fixture.

14. The method of claim 13 wherein a tenth work cell comprises the standardized workpiece presenter comprising a fixture in a tool, and the processing tool is selected from the group consisting essentially of a hemming tool, a clinching tool, and a piercing tool.

15. The method of claim 14 wherein an eleventh work cell comprises the standardized workpiece presenter comprising a sliding tool plate on an indexing shuttle and the processing tool is a plurality of tools selected from the group consisting essentially of a welding robot, a material handling robot, a sealant dispenser, and an adhesive dispenser.

16. The method of claim 15 wherein a twelfth work cell comprises the standardized workpiece presenter comprising a pallet that is received on a roller bed and the processing tool is a plurality of tools selected from the group consisting essentially of a welding robot, a material handling robot, a sealant dispenser, and an adhesive dispenser.

17. The method of claim 16 wherein a thirteenth work cell comprises the standardized workpiece presenter comprising a pallet and the processing tool is a vision work cell having optical measuring devices.

18. The method of claim 17 wherein a fourteenth work cell comprises the standardized workpiece presenter comprising a shuttling tooling plate mounted on a shuttle drive and the processing tool is a sealant applicator.

19. The method of claim 18 wherein a fifteenth work cell comprises the standardized workpiece presenter comprising a pallet that is received on a roller bed and the processing tool is a welding robot.

20. The method of claim 19 wherein a sixteenth work cell comprises the standardized workpiece presenter comprising a framer for joining a vehicle body side to an underbody that is mounted on a pallet on a roller bed and the processing tool is a welding gate fixture.
